(19) United States
(12) Patent Application Publication
(10) Pub. No.: US 2019/0049609 A1
(43) Pub. Date: Feb. 14, 2019

(54) SOURCE SEPARATION METHOD

(71) Applicant: SEISMIC APPARITION GmbH, Zurich (CH)

(72) Inventors: Dirk-Jan VAN MANEN, Otelfingen (CH); Fredrik ANDERSSON, Esloev (SE); Johan ROBERTSSON, Wald (CH); Kurt EGGENBERGER, Maienfeld (CH)

(73) Assignee: SEISMIC APPARITION GmbH, Zurich (CH)

(21) Appl. No.: 16/119,790

(22) Filed: Aug. 31, 2018

Related U.S. Application Data
(63) Continuation of application No. PCT/IB2017/051061, filed on Feb. 24, 2017.

(30) Foreign Application Priority Data
Mar. 4, 2016 (GB) 1603742.6
Nov. 10, 2016 (GB) 1619034.0

(51) Int. Cl. G01V 1/30; G01V 1/28; G01V 1/20

(52) U.S. Cl. CPC G01V 1/303; G01V 1/307; G01V 1/20; G01V 1/282

(57) ABSTRACT

A method and apparatus for separating the unknown contributions of two or more sources from a commonly acquired wave field including the determination of a wavenumber dependent model which reconstructs the wave field of the sources independently below a frequency set by the slowest physical propagation velocity, and applying an inversion based on the model to the commonly acquired wave field to separate the contributions.

### CROSS-REFERENCE TO RELATED APPLICATIONS

This application is a continuation of PCT Application No. PCT/IB2017/051061, filed Feb. 24, 2017, which claims priority to Great Britain Application No. 1603742.6, filed Mar. 4, 2016, and Great Britain Application No. 1619034.0, filed Nov. 10, 2016. The entire contents of the above-identified applications are incorporated herein by reference.

### FIELD

The present disclosure relates to methods for separating contributions from two or more different sources in a common set of measured signals representing a wave field, particularly of seismic sources and of sets of recorded and/or processed seismic signals.

### DESCRIPTION OF RELATED ART

The current disclosure relates to marine seismic surveying, including in particular marine seismic data acquisition. The general practice of marine seismic surveying is described below in relation to FIG. 7.

Prospecting for subsurface hydrocarbon deposits (701) in a marine environment (FIG. 7) is routinely carried out using one or more vessels (702) towing seismic sources (703-705). The one or more vessels can also tow receivers or receivers (706-708) can be placed on the seabed (714).

Seismic sources typically employ a number of so-called airguns (709-711) which operate by repeatedly filling up a chamber in the gun with a volume of air using a compressor and releasing the compressed air at suitable chosen times (and depth) into the water column (712).

The sudden release of compressed air momentarily displaces the seawater, imparting its energy on it, setting up an impulsive pressure wave in the water column propagating away from the source at the speed of sound in water (with a typical value of around ˜1500 m/s) (713).

Upon incidence at the seafloor (or seabed) (714), the pressure wave is partially transmitted deeper into the subsurface as elastic waves of various types (715-717) and partially reflected upwards (718). The elastic wave energy propagating deeper into the subsurface partitions whenever discontinuities in subsurface material properties occur. The elastic waves in the subsurface are also subject to an elastic attenuation which reduces the amplitude of the waves depending on the number of cycles or wavelengths.

Some of the energy reflected upwards (720-721) is sensed and recorded by suitable receivers placed on the seabed (706-708), or towed behind one or more vessels. The receivers, depending on the type, sense and record a variety of quantities associated with the reflected energy, for example, one or more components of the particle displacement, velocity or acceleration vector (using geophones, mems [micro-electromechanical] or other devices, as is well known in the art), or the pressure variations (using hydrophones). The wave field recordings made by the receivers are stored locally in a memory device and/or transmitted over a network for storage and processing by one or more computers.

Waves emitted by the source in the upward direction also reflect downward from the sea surface (719), which acts as a nearly perfect mirror for acoustic waves.

One seismic source typically includes one or more airgun arrays (703-705): that is, multiple airgun elements (709-711) towed in, e.g., a linear configuration spaced apart several meters and at substantially the same depth, whose air is released (near-) simultaneously, typically to increase the amount of energy directed towards (and emitted into) the subsurface.

Seismic acquisition proceeds by the source vessel (702) sailing along many lines or trajectories (722) and releasing air from the airguns from one or more source arrays (also known as firing or shooting) once the vessel or arrays reach particular pre-determined positions along the line or trajectory (723-725), or, at fixed, pre-determined times or time intervals. In FIG. 7, the source vessel (702) is shown in three consecutive positions (723-725), also called shot positions.

Typically, subsurface reflected waves are recorded with the source vessel occupying and shooting hundreds of shots positions. A combination of many sail-lines (722) can form, for example, an areal grid of source positions with associated inline source spacings (726) and crossline source spacings. Receivers can be similarly laid out in one or more lines forming an areal configuration with associated inline receiver spacings (727) and crossline receiver spacings.

A common and long-standing problem in physical wave field experimentation is how to separate recorded signals from two or more simultaneously emitting sources. In particular, for more than a decade, the simultaneous source problem has (arguably) been the most pertinent problem to solve to efficiently acquire data for 3D reflection seismic imaging of complex Earth subsurface structures.

### SUMMARY

A method for separating wave fields generated by two or more sources contributing to a common set of measured or recorded signals are provided suited for seismic applications and other purposes, substantially as shown in and/or described in connection with at least one of the figures, and as set forth more completely in the claims.

Advantages, aspects and novel features of the present disclosure, as well as details of illustrated embodiments thereof, may be more fully understood from the following description and drawings.

### BRIEF DESCRIPTION OF THE DRAWINGS

In the following description reference is made to the attached figures, in which:

FIGS. 1A and 1B illustrate how in a conventional marine seismic survey all signal energy of sources typically sits inside a “signal cone” bounded by the propagation velocity of the recording medium and how this energy can be split in a transform domain by applying a modulation to a second source;

FIG. 2 shows jointly recorded wave field data from two sources measured at a stationary receiver;

FIG. 3 shows time delays as applied to the second source in the data of FIG. 2;

FIGS. 4 A-4 C show the original and the reconstructed wave field of the first source in the data of FIG. 2 and the reconstruction error when reconstructing the wave field of the source after applying the separation method;

FIG. 5 shows the relative time delays between two sources as used in another example;

FIGS. 6A and 6B illustrate the construction and separate reconstruction of the wave fields of two sources in the example of FIG. 5;

FIG. 7 illustrates the general practice of marine seismic surveying;

FIG. 8 summarizes key steps in the methods proposed herein in a flowchart;

FIG. 9 provides details regarding the steps involved in the iterative solution of a system of equations; and

FIG. 10 illustrates hardware components of a computer.

### DETAILED DESCRIPTION

Modern digital data processing of wave fields (or signals) uses a discretized version of the original wave field, say g, that is obtained by sampling g on a discrete set. The Nyquist-Shannon sampling theorem shows how g can be recovered from its samples; for an infinite number of equidistant samples and given sample rate k₋s, perfect reconstruction is guaranteed provided that the underlying signal was bandlimited to |k|≤k₋N=k₋s/2 (Shannon, 1949; Nyquist, 1928), where k₋N is the so-called Nyquist wavenumber. The Nyquist-Shannon sampling theorem is equally relevant both to signals generated from a single source being recorded on multiple receivers (receiver-side sampling) as well as signals generated from multiple sources and recorded at a single receiver (source-side sampling).

Assume that the wave field g is measured at a specific recording location for a source that is excited at different source positions along an essentially straight line. The sampling theorem then dictates how the source locations must be sampled for a given frequency of the source and phase velocity of the wave field. One aspect of the sampling problem addressed in the current disclosure is as follows. Instead of using one source, we want to use two (or more) sources to, for instance, increase the rate at which data can be acquired. The second source is triggered simultaneously or close in time with the first source while moving along another arbitrarily oriented line to excite the wave field h. At the recording location the wave fields interfere and the sum of the two wave fields, f=g+h, is now measured. There is no known published exact solution to perfectly separate the wave fields g and h that were produced from each source from the combined measurement f (e.g., see Ikelle, 2010; Abma et al., 2015; Kumar et al, 2015; Mueller et al., 2015).

It may therefore be seen as an object of the disclosure, to provide new and improved methods for generating source-separated data. It may also be seen as an object of the present disclosure to extend such methods into fields, where they have not been applied before, such as estimation and removal of seismic interference.

The following examples may be better understood using a theoretical overview as presented below.

The slowest observable (apparent) velocity of a signal along a line of recordings in any kind of wave experimentation is identical to the slowest physical propagation velocity in the medium where the recordings are made. As a result, after a spatial and temporal Fourier transform, large parts of the frequency-wavenumber (ωk) spectrum inside the Nyquist frequency and wavenumber tend to be empty. In particular, for marine reflection seismic data (Robertsson et al., 2015), the slowest observable velocity of arrivals corresponds to the propagation velocity in water (around 1500 m/s).

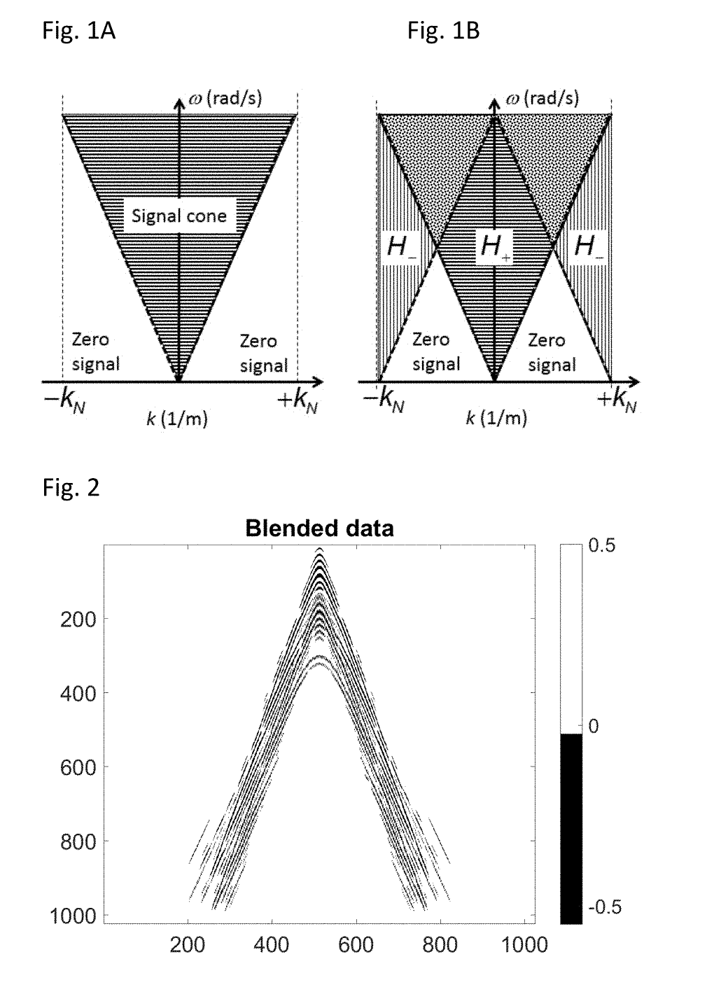

FIG. 1A illustrates how all signal energy when represented in or transformed into the frequency-wavenumber (ωk) domain sits inside a “signal cone” centered at k=0 and bounded by the propagation velocity of the recording medium.

In a wave field experiment it may be that a source is excited sequentially for multiple source locations along a line while recording the reflected wave field on at least one receiver. The source may be characterized by its temporal signature. In the conventional way of acquiring signals representing a wave field the source may be excited using the same signature from source location to source location, denoted by integer n. Next, consider the alternative way of acquiring such a line of data using a periodic sequence of source signatures: every second source may have a constant signature and every other second source may have a signature which can for example be a scaled or filtered function of the first source signature. Let this scaling or convolution filter be denoted by a(t), with frequency-domain transform A(ω). Analyzed in the frequency domain, using for example a receiver gather (one receiver station measuring the response from a sequence of sources) recorded in this way, can be constructed from the following modulating function m(n) applied to a conventionally sampled and recorded set of wave field signals:

m(n)=½[1+(−1)ⁿ]+½A[1−(−1)ⁿ],

which can also be written as

m(n)=½[1+e^{iπn}]+½A[1−e^{iπn}]. (0.1)

By applying the function m in Eq. 0.1 as a modulating function to data f(n) before taking a discrete Fourier transform in space (over n), F(k)= [symbol] (f(n)), the following result can be obtained:

$$ℱ ( f ( n ) m ( n ) ) = \frac{1 + A}{2} F ( k ) + \frac{1 - A}{2} F ( k - {k}_{N} ) , \qquad ( 0.2 )$$

which follows from a standard Fourier transform result (wavenumber shift) (Bracewell, 1999).

Eq. 0.2 shows that the recorded data f will be mapped into two places in the spectral domain as illustrated in FIG. 1B and as quantified in Tab. I for different choices of A (ω).

TABLE I
Mapping of signal to cone centered at k = 0 (H₊) and
cone centered at k = k_{N} (H₋) for different choices
of A(ω) for signal separation or signal apparition
in Eq. (0.2).

| A (ω) | H₋ = (1 − A)/2 | H₊ = (1 + A)/2 |
|---|---|---|
| 1 | 0 | 1 |
| −1 | 1 | 0 |
| 0 | ½ | ½ |
| ½ | ¼ | ¾ |
| e^{iωT} | (1 − e^{iωT})/2 | (1 + e^{iωT})/2 |
| 1 + e^{iωT} | − e^{iωT}/2 | 1 + e^{iωT}/2 |

Part of the data will remain at the signal cone centered around k=0 (denoted by H₊ in FIG. 1B) and part of the data will be mapped to a signal cone centered around k_{N} (denoted by H₋). It can be observed that by only knowing one of these parts of the data it is possible to predict the other.

A particular application of interest that can be solved by using the result in Eq. (0.2) is that of simultaneous source separation. Assume that a first source with constant signature is moved along an essentially straight line with uniform sampling of the source locations where it generates the wave field g. Along another essentially straight line a second source is also moved with uniform sampling. Its signature is varied for every second source location according to the simple deterministic modulating sequence m(n), generating the wave field h. The summed, interfering data f=g+h are recorded at a receiver location.

In the frequency-wavenumber domain, where the recorded data are denoted by F=G+H, the H-part is partitioned into two components H₊ and H₋ with H=H+H₋ where the H₋-component is nearly “ghostly apparent” and isolated around the Nyquist-wavenumber [FIG. 1B], whereas G and H₊ are overlapping wave fields around k=0. Furthermore, H₋ is a known, scaled function of H. The scaling depends on the chosen A(ω) function (Tab. I), and can be deterministically removed, thereby producing the full appearance of the transformed wave field H. When H is found, then G=F−H yielding the separate wave fields g and h in the time-space domain.

The concept may be extended to the simultaneous acquisition of more than two source lines by choosing different modulation functions for each source.

Acquiring a source line where the first two source locations have the same signature, followed by another two with the same signature but modified from the previous two by the function A(ω) and then repeating the pattern again until the full source line has been acquired, will generate additional signal cones centered around ±k_{N}/2.

This process may be referred to as “wave field apparition” or “signal apparition” in the meaning of “the act of becoming visible”. In the spectral domain, the wave field caused by the periodic source sequence is nearly “ghostly apparent” and isolated.

FIG. 1B also illustrates a possible limitation of signal apparition. The H₊ and H₋ parts are separated within the respective lozenge-shaped regions in FIG. 1B. In the triangle-shaped parts they interfere and may no longer be separately predicted without further assumptions. In the example shown in FIG. 1B, it can therefore be noted that the maximum unaliased frequency for a certain spatial sampling is reduced by a factor of two after applying signal apparition. Assuming that data are adequately sampled, the method nevertheless enables full separation of data recorded in wave field experimentation where two source lines are acquired simultaneously.

As is evident from Tab. I, the special case A=1 corresponds to regular acquisition and thus produces no signal apparition. Obviously, it is advantageous to choose A significantly different from unity so that signal apparition becomes significant and above noise levels. The case where A=−1 (acquisition of data where the source signature flips polarity between source locations) may appear to be the optimal choice as it fully shifts all energy from k=0 to k_{N} (Bracewell, 1999). Although this is a valid choice for modeling, it is not practical for many applications (e.g., for marine air gun sources, see Robertsson et al., 2015) as it requires the ability to flip polarity of the source signal. The case where A=0 (source excited every second time only) may be a straightforward way to acquire simultaneous source data but has the limitation of reduced sub-surface illumination. A particularly attractive choice of A(ω) for wave experimentation seems to let every second source be excited a time shift T later compared to neighbouring recordings, that is, select A=e^{iωT}.

The above description assumes a simple modulating sequence m(n), and thus generating the wave field h. Applications in which such a simple modulating sequence can be applied may however be limited in practice. In practice it is difficult to obtain perfectly periodic time shifts from a measurement setup. It is for example common practice for seismic vessels to shoot or trigger their sources at predetermined (essentially equidistant) positions, and due to practical variations (vessel velocity etc.) it will be difficult to realize shots at both predetermined locations and times.

In the following, there are therefore described further methods accommodating applications in which the modulation sequence includes variations or deviations, signal dither, or, in extreme circumstances, gives rise to aperiodic source signals. We refer herein to modulations sequences including any such variations as non-periodic.

First are presented methods for treating simultaneous source data using quasi-periodic time delays in the shots as well as position variations. Quasi-periodic time delays can be understood as delays with periodic carrying signal overlaid with a non-periodic (for instance random) pattern. The resulting combined variation can therefore be considered to be non-periodic. In the case where the recorded data is band-limited, and sufficiently densely sampled, this may provide a way to conduct separation or deblending of two or more source contributions for moderately sized non-periodic variations in the time shift.

Let us start by recapitulating some one-dimensional properties of the Fourier transform. We will use the notation

\grave{ƒ}(ξ)=∫_{-∞}^{∞}ƒ(x)e^{-2πixξ}dx

for the Fourier transform in one variable, and consequently \grave{ƒ}(ω,ξ) for the Fourier transform of two dimensional function ƒ(t,x) with a time (t) and spatial (x) dependence.

The Poisson sum formula

$${\sum }_{k = - ∞}^{∞} f ( k ) = {\sum }_{k = - ∞}^{∞} {f}^{‵} ( k )$$

can be modified (by using the Fourier modulation rule) as

$${\sum }_{k = - ∞}^{∞} f ( k ) {e}^{- 2 π i ξ k} = {\sum }_{k = - ∞}^{∞} ℱ ( f ( \cdot ) {r}^{- 2 π i ξ \cdot } ) ( k ) = {\sum }_{k = - ∞}^{∞} {f}^{‵} ( ξ + k ) .$$

By the standard properties of the Fourier transform it is straightforward to show that

$${\sum }_{k = - ∞}^{∞} f ( k {Δ}_{x} + {x}_{0} ) {e}^{- 2 π i ( k {Δ}_{x} + {x}_{0} ) ξ} = \frac{1}{{Δ}_{x}} {\sum }_{k = - ∞}^{∞} {f}^{‵} ( ξ + \frac{k}{{Δ}_{x}} ) {e}^{- 2 π {ix}_{0} \frac{k}{{Δ}_{x}}}$$

hold for the spatial sampling parameter Δₓ and some fixed spatial shift x₀. Suppose that ƒ₁=ƒ₁(t,x) and ƒ₂=ƒ₂(t,x) are two spatially bandlimited functions. By rescaling of units we can thus assume that they satisfy

\grave{ƒ}₁(ω,ξ)=\grave{ƒ}₂(ω,ξ)=0, if |ξ|>¼. (1.1)

The recorded data is now modelled as a sum of the two functions, but where one of them has been subjected to a periodic time shift. Denote the recorded data by d=d(t,x), this blending can thus be described by

$$d ( t , k ) = {f}_{1} ( t , k ) + {f}_{2} ( t - {{Δ}_{t} ( - 1 )}^{k} , k ) = {ℱ}^{*} ( {{f}^{‵}}_{1} ) ( t , k ) + {ℱ}^{*} ( {{f}^{‵}}_{2} ( ω , ξ ) {e}^{- 2 π {i ( - 1 )}^{k} {Δ}_{t} ω} ) ( t , k ) ,$$

where we assume that the data is spatially sampled at equally spaced points x=k.
In a more general version more general filtering operations than time shifts can be applied. Let aₖ be filter operators (acting on the time variable) where the k dependence is such it only depends on if k is odd or even, i.e., that aₖ=a_{k(mod2)}.

$$d ( t , k ) = {f}_{1} ( t , k ) + {a}_{k} {f}_{2} ( t - {{Δ}_{t} ( - 1 )}^{k} , k ) = {ℱ}^{*} ( {{f}^{‵}}_{1} ) ( t , k ) + {ℱ}^{*} ( {{f}^{‵}}_{2} ( ω , ξ ) {e}^{- 2 π {i ( - 1 )}^{k} {Δ}_{t} ω} ) ( t , k ) .$$

Applying the result described above, it then follows that a modulated sum of d over all even points (2k) in combination with a one-dimensional Fourier transform in the time variable yield the relation

$${\int }_{- ∞}^{∞} {\sum }_{k = - ∞}^{∞} d ( t , 2 k ) {r}^{- 2 π i ( ( 2 k ) ξ + t ω )} dt = \frac{1}{2} {\sum }^{k} {{f}^{‵}}_{1} ( ω , ξ + \frac{k}{2} ) + {{a}^{‵} }_{0} ( ω ) {{f}^{‵}}_{2} ( ω , ξ + \frac{k}{2} ) {e}^{- 2 π i {Δ}_{t} ω} ,$$

A similar treatment of the odd terms (2k+1) gives

$${\int }_{- ∞}^{∞} {\sum }_{k = - ∞}^{∞} d ( t , 2 k + 1 ) {e}^{- 2 π i ( ( 2 k + 1 ) ξ + t ω )} dt = \frac{1}{2} {\sum }_{k = - ∞}^{28 } ( {{f}^{‵}}_{1} ( ω , ξ + \frac{k}{2} ) + {{a}^{‵}}_{1} ( ω ) {{f}^{‵}}_{2} ( ω , ξ + \frac{k}{2} ) {e}^{2 π i {Δ}_{t} ω} ) {( - 1 )}^{k} .$$

We now define D₁(ω,ξ) as the sum that includes both odd and even terms. It thus holds that

$${D}_{1} ( ω , ξ ) = {\int }_{- ∞}^{∞} {\sum }_{k = - ∞}^{∞} d ( t , k ) {e}^{- 2 π i ( k ξ + t ω )} dt = ( {\sum }_{{∞}_{k = - ∞}} {{f}^{‵}}_{1} ( ω , ξ + k ) ) + ( {\sum }_{{∞}_{k = - ∞}} {{f}^{‵}}_{2} ( ω , ξ + \frac{k}{2} ) \frac{1}{2} ( {{a}^{‵}}_{0} ( ω ) {e}^{- 2 π i {Δ}_{t} ω} + {( - 1 )}^{k} {{a}^{‵}}_{1} ( ω ) {e}^{2 π i {Δ}_{t} ω} ) ) . \qquad ( 1.2 )$$

Because of the support assumption (1.1), we see that if |ξ+½|<¼, then most of the terms above vanish, and it is therefore possible to obtain the values of \grave{ƒ}₂ (ξ) from

D₁(ω,ξ)=(à₀(ω)e^{-2πiΔ}^{ₜ}^{ω}+(−1)^{k}à₁(ω)e^{2πiΔ}^{ₜ}^{ω})\grave{ƒ}₂(ω,ξ−½)

The values of \grave{ƒ}₁ can be obtained in a similar fashion by considering instead

$${D}_{2} ( ω , ξ ) = {\int }_{- ∞}^{∞} {\sum }^{k} d ( t + {{Δ}_{t} ( - 1 )}^{k} , k ) {e}^{- 2 π i ( k ξ + t ω )} dt , \\ and$$

$${D}_{2} ( ω , ξ ) = ( {{a}^{‵}}_{0} ( ω ) {e}^{- 2 π i {Δ}_{t} ω} + {( - 1 )}^{k} {{a}^{‵}}_{1} ( ω ) {e}^{2 π i {Δ}_{t} ω} ) {{f}^{‵}}_{1} ( ω , ξ - \frac{1}{2} ) .$$

The role of the filtering operations à₀ and à₁ are thus merely multiplicative, and for the sake of simplifying the presentation we therefore satisfy with considering the case where à₀=à₁=1 for which it holds that

D₁(ω+½′ξ)=−i sin(2πΔₜω)\grave{f}₂(ω,ξ).

and

D₂(ω+½′ξ)=−i sin(2πΔₜω)\grave{ƒ}₁(ω,ξ).

Like in the method above this procedure uses recovering the respective function at the cones that shifted away from the origin. While the values of \grave{ƒ}₁ and \grave{ƒ}₂ can be obtained in a very direct manner, the procedure is heavily relying on the periodicity of the alternating shifts in sampling, and may therefore be sensitive to perturbations of these time shifts.

It should be noted that a similar result can be obtained by modulating the amplitude instead of the time. In the most general case the modulation can be a filter with frequency dependent amplitude and phase.

Another way to recover \grave{ƒ}₁ and \grave{ƒ}₂ is to consider the case where |ξ|<¼, for which (1.2) simplifies to

$${\int }_{- ∞}^{∞} {\sum }^{k} d ( t , k ) {e}^{- 2 π i ( k ξ + t ω )} dt = {{f}^{‵}}_{1} ( ω , ξ ) + {{f}^{‵}}_{2} ( ω , ξ ) cos ( 2 π {Δ}_{t} ω ) ,$$

and similarly for the shifted version

$${\int }_{- ∞}^{∞} {\sum }^{k} d ( t + {{Δ}_{t} ( - 1 )}^{k} , k ) {e}^{- 2 π i ( k ξ + t ω )} dt = {{f}^{‵}}_{1} ( ω , ξ ) cos ( 2 π {Δ}_{t} ω ) + {{f}^{‵}}_{2} ( ω , ξ ) .$$

This implies that for each pair of values (ω,ξ) (with |ξ|<¼ and ωΔₜ∉ [symbol] ), \grave{ƒ}₁ (ωξ) and \grave{f}₂(ω,ξ) can be obtained by solving the linear system

$$( \begin{matrix}1 & cos ( 2 π {Δ}_{t} ω ) \\ cos ( 2 π {Δ}_{t} ω ) & 1\end{matrix} ) ( \begin{matrix}{{f}^{‵}}_{1} ( ω , ξ ) \\ {{f}^{‵}}_{2} ( ω , ξ )\end{matrix} ) = ( \begin{matrix}{D}_{1} ( ω , ξ ) \\ {D}_{2} ( ω , ξ )\end{matrix} ) . \\ or \\ {{f}^{‵}}_{1} ( ω , ξ ) = \frac{{D}_{1} ( ω , ξ ) - cos ( 2 π {Δ}_{t} ω ) {D}_{2} ( ω , ξ )}{{sin}^{2} ( 2 π {Δ}_{t} ω )} , \\ {{f}^{‵}}_{2} ( ω , ξ ) = \frac{{D}_{2} ( ω , ξ ) - cos ( 2 π {Δ}_{t} ω ) {D}_{1} ( ω , ξ )}{{sin}^{2} ( 2 π {Δ}_{t} ω )} . \qquad ( 1.3 )$$

In this way the function can thus be recovered by considering the data in the central cone (e.g. as shown in FIG. 1B) alone. The different formulations could have different advantages, for instance in the presence of noise.

Let us now consider a more general sampling setup. Let t= [symbol] tₖ [symbol] and s= [symbol] sₖ [symbol] be two sequences and assume that data is modelled by

d(t,k)=ƒ₁(t,sₖ)+aₖƒ₂(t+tₖ,sₖ). (1.4)

In the case where

tₖ=Δₜ(−1)^{k} and sₖ=k, and aₖ=1, (1.5)

the setup of the previous section is obtained. Let us introduce the operators [symbol] _{t,s}*, and [symbol] _{t,s} by

$${ℱ}_{t , s}^{*} {f}^{‵} ( t , {s}_{k} ) = {\int }_{- ∞}^{∞} {\int }_{- ∞}^{∞} {{a}^{‵}}_{k} ( ω ) {f}^{‵} {e}^{2 π i ( ξ {s}_{k} + ω ( t + {t}_{k} ) )} d ω d ξ , \\ and$$

$${ℱ}_{t , s} d ( t , k ) = {{a}^{‵}}_{k} ( ω ) {\sum }_{k = - ∞}^{∞} {\int }_{- ∞}^{∞} d ( t + {t}_{k} , k ) {e}^{2 π i ( ξ {s}_{k} + ω t )} dt ,$$

respectively. Note that (1.4) can now be written as

d(t,k)= [symbol] _{0,s}*\grave{ƒ}₁(t,sₖ)+ [symbol] _{t,s}*\grave{ƒ}₂(t,sₖ).

Note also that for instance F_{-t,s} [symbol] _{t,s}*\grave{ƒ}= [symbol] _{0,s} [symbol] _{0,s}*\grave{ƒ} since the two time shifts cancel out.

Given a support constraint similar to (1.1), we follow the reconstruction procedure in a similar fashion as in the previous section. The analogous system of equations becomes

$$\{ \begin{matrix}{ℱ}_{0 , s} {ℱ}_{0 , s}^{*} {{f}^{‵}}_{1} + {ℱ}_{0 , s} {ℱ}_{t , s}^{*} {{f}^{‵}}_{2} = {ℱ}_{0 , s} d , \\ {ℱ}_{0 , s} {ℱ}_{- t , s}^{*} {{f}^{‵}}_{1} + {ℱ}_{0 , s} {ℱ}_{0 , s}^{*} {{f}^{‵}}_{2} = {ℱ}_{- t , s} d .\end{matrix} \qquad ( 1.6 )$$

Using a standard discretization in the frequency domain (and time), the operators may be realized using standard FFT in combination with shift operators in the case of equally spaced sampling in the spatial variable, or by using algorithms for unequally spaced FFT in the general case. The linear system (1.6) can for instance be solved by using an iterative solver. If (1.5) is approximately satisfied, the solution (1.3) may be used as a preconditioner. This means that a solution should be obtained in one iteration if (1.5) is satisfied and in case it is almost satisfied, only a few iterations should be required. The formulation above can be used in the case of irregular sampling in time; in space; or for both of the at the same time. Perturbations that are completely irregular (not following the tensor structure indicated here) can also be dealt with using the same framework.

For computational reasons it is important to be able to use fast solvers when applicable. By a fast solver we mean a method by which we can solve the problem of computing either forward or inverse operators in a method with low time complexity, for instance that of FFT.

The method set out above can be applied to various cases in which a separation of sources may be considered as advantageous. In the following the application of the problem of seismic interference cancellation is demonstrated.

Seismic interference (SI) occurs when two or more different seismic crews are acquiring seismic data in vicinity of each other. SI can be a major source of noise that can be difficult to remove particularly if it is arriving in the cross-line direction as the moveout of the signal is very similar to that of the interfering signal which can also be strong compared to deeper reflections that it may overlie. If the dominant azimuth of seismic interference is known, it is possible to shift the acquired data so that it appears as far as possible from the seismic interference noise in wk (e.g., noise centered at k=0 and signal at k_{Nyquist}). The application requires real-time knowledge of exact firing times of the interfering vessel.

Knowledge of the exact firing time is of course a major limitation as a competing seismic crew likely will not want to share this information. It may also be somewhat irregular if the crew shoots on position and not time. However, using for instance the quasi-periodic apparition method presented above we can not only solve the simultaneous source problem (as described above) but also that of seismic interference since we do not need to know the exact firing times of the interfering crew beforehand. As long as we utilize a periodic or quasi-periodic acquisition sequence ourselves we will record a data set where the interfering signal can be apparated and removed from the acquired data. Once the data have been recorded we can detect the exact arrival time of the seismic interference in the data (this can be as simple as a windowed autocorrelation/crosscorrelation process).

The interfering data will likely be shot on position and therefore have a slight variation in arrival time from shot to shot. However, all we have to do is to include these estimated perturbations in arrival time of the seismic interference to apparate (i.e., shift in wavenumber) the seismic interference away from the acquired data. As a side note we note that the interfering survey is likely also seeing interference from the first crew using the apparition firing sequence. The method applied gives the opportunity to generate a separate set of data for the interfering survey.

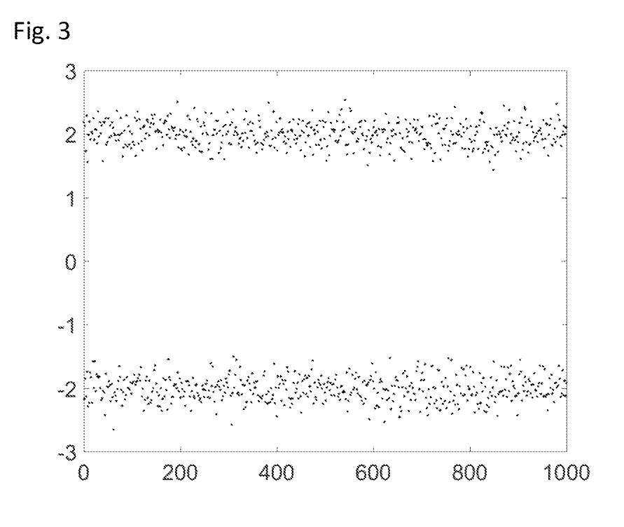

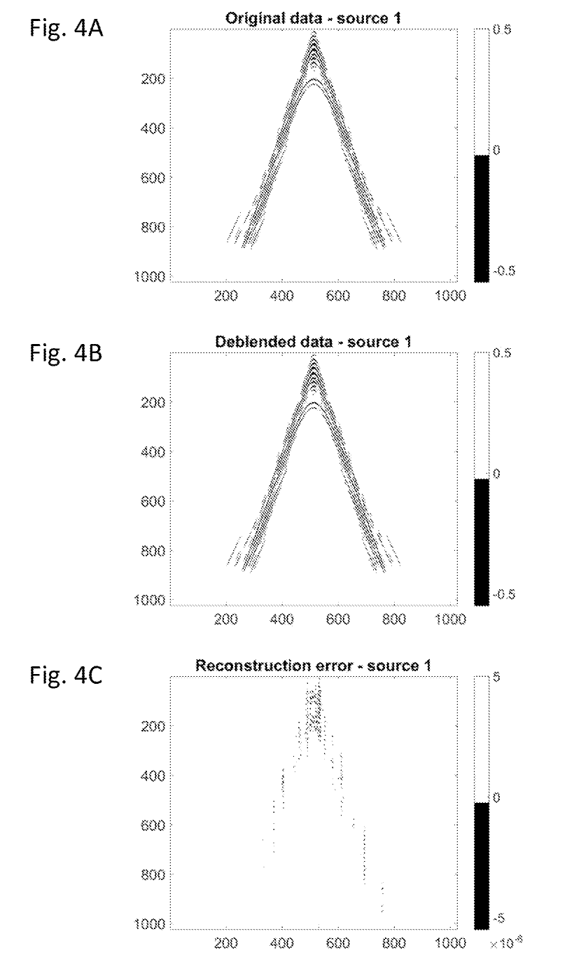

Synthetic data were computed using a finite-difference solution of the wave equation for a typical two-dimensional (2D) North Sea subsurface velocity and density model consisting of sub horizontal sediment layers overlying rotated fault blocks. The data consist of the waveforms recorded at a single stationary receiver (located on the seafloor) for shots along a line. The data are shown in FIG. 2. The time shifts t that have been applied to the second source are shown in FIG. 3, and the spatial sampling s is equidistant. An iterative scheme (preconditioned conjugate gradient) has been applied to the formulation using a preconditioner to obtain separated reconstructions of the data originating from each of the two sources. The data and the corresponding reconstruction and its error for the first source are shown in FIG. 4, while the counterparts for the second source (not shown) can be either derived directly from the above method or by subtracting the wave field of the first source from the blended data. In this case 20 iterations of the iterative scheme were used. In this case the data were assumed to satisfy the bandlimit condition (1.1), and it is clear from the FIG. 4 that the reconstruction errors in this case can be made very small.

In the following variant of the method as described above is focusing on the cases of quasi-periodic and or pseudo-random timeshifts. Note, however, that the method can also be applied to the case of quasi-periodic or pseudo-random amplitude perturbations or to such perturbations of shot positions or of frequency-dependent amplitude and phase perturbations or arbitrary combinations thereof. This variant of the method, in its most general form, applies to any known (set of) modulation function(s).

Let d(n) represent some data acquired as a function of a spatial coordinate x, i.e., at discrete locations xₙ. The well-known convolution theorem states that the convolution in space of the data d(n) with some spatial filter ƒ(n) can be computed by multiplication of the (discrete) Fourier transforms of the data D(k)= [symbol] (d(n)) and of the spatial filter, F(k)= [symbol] (f(n)), followed by inverse (discrete) Fourier transform, i.e., ƒ(n)*d(n)= [symbol] ⁻¹ (F(k)·D(k)). Here we exploit the lesser-known dual of the convolution theorem, which states that multiplication in the space domain of d(n) with a so-called modulation function/operator m(n), corresponds to cyclic convolution of the (discrete) Fourier transform of the data, D(k), with the (discrete) Fourier transform of the modulation operator M(k)= [symbol] (m(n)), followed by inverse (discrete) Fourier transform. Furthermore, we exploit the fact that cyclic convolution can be expressed conveniently as a matrix multiplication with a Toeplitz matrix.

Moreover, such a matrix multiplication can be rapidly evaluated by means of fast solvers such as the FFT, since the discrete Fourier matrices diagonalize cyclic matrices. This property is not true for the inverse of Toeplitz matrices. However, both Toeplitz matrices and their inverses have displacement rank 2, which allows for rapid evaluation of the application of these operators. The time complexity for these operations are bounded by the complexity for FFT.

Without loss of generality, let's assume that the data have been acquired in the following manner: a first source, s₁, sailing with a constant ground speed, fires with regular time intervals, and a second source, s₂, sailing also with a constant ground speed (and along the same line), fires alternately at the same time as s₁ and at Δtₙ after s₁, where Δtₙ is drawn, e.g., from a normal distribution, N(μ,σ²) with mean, μ, and variance, σ². Since s₁ and s₂ are fired at the same time or shortly after each other, a recording of subsurface reflected waves will comprise a superposition of waves due to these two sources.

As shown below, we can formulate the separation of such data as the (least-squares) solution of a system of equations in the frequency-wavenumber domain. Let the N shots be enumerated by n, and let Tₙ denote the relative timing of the n-th shots fired by s₁ and s₂. Thus, according to the paragraph above, Tₙ=0 for odd shots n=2·i+1 and Tₙ=Δtₙ for even shots=2·i+2 (i=0, 1, 2, . . . for n≤N). In the temporal frequency domain, the effect of the timeshift is multiplication with e^{±iωT}^{ₙ} where the sign depends on the choice of the definition of the temporal Fourier transform. Thus, for a particular frequency to ω′ and shot n′ the time delay acts as a complex modulation m(n′)=e^{±iω′T}^{_{n′}}. As before, let M(k)= [symbol] (m(n)) denote the spatial (discrete) Fourier transform of the modulation function m(n). A cyclic convolution matrix C can be formed by taking as the columns of C, circularly shifted versions of M, with the circular shift increasing by one each column, and having as many columns as number of points in M.

Since the timeshifts are formulated as relative to the s₁ times, the effective modulation function for the part of the simultaneous data due to s₁ is constant equal to 1 for each s₁ shot and each frequency. Thus, the transform of the implied modulation function for s₁ is a (discrete) delta function in wavenumber (at zero wavenumber) and the corresponding cyclic convolution matrix the identity matrix, I.

Consider without loss of generality that the number of simultaneous source recorded traces N is even. Let Δx denote the spatial (shot) sampling interval. Then the spatial Nyquist wavenumber, K_{N}, is K_{N}=1/(2Δx), and the wavenumber resolution, Δk, after a discrete Fourier transform over space is Δk=2K_{N}/N. The discrete wavenumbers (after “FFT-shifting” the zero-wavenumber component to the center of the spectrum by swapping halves of the obtained decrete Fourier transform values) are (k)=−K_{N}+(k−1)Δk (k=1, 2, . . . , N). In this case, the index corresponding to the zero wavenumber, k₀, is

$$\frac{N}{2} + 1.$$

Let the unknowns be the data in the frequency wavenumber domain due to sources s₁ and s₂, i.e. D₁(k) and D₂(k), respectively, without relative timeshifts. Let kₘᵢₙ and kₘₐₓ denote the indices of the discrete wavenumbers closest to the minimum and maximum wavenumbers Kₘᵢₙ and Kₘₐₓ to be inverted, but smaller and larger, respectively. The data between −K_{N} and Kₘᵢₙ and Kₘₐₓ and K_{N} are assumed to be zero (i.e., the support in the wavenumber domain of D₁(k) and D₂(k) is confined to Kₘᵢₙ and Kₘₐₓ).

Thus, the (column) vector of unknowns can be denoted D=[D₁(kₘᵢₙ:kₘₐₓ)^{T} D₂(kₘᵢₙ:kₘₐₓ)^{T}]^{T} where ^{T} denotes transpose and the colon denotes all or part of a range. Note, however, that because of the modulation function applied to s₁ data, the range of observed wavenumbers is not restricted to from Kₘᵢₙ to Kₘₐₓ. However, since the unknowns are restricted to that range, the forward modelling operator should be similarly restricted along the columns (i.e., on the model side) but not along the rows (i.e., on the measurement side). Thus, the forward modelling operator matrix G can be formed:

G=[I(:kₘᵢₙ:kₘₐₓ)C(:kₘᵢₙ:kₘₐₓ)]

Thus, if we denote Dₜₒₜ(k) the FFT-shifted (discrete) Fourier transform of the observed aperiodic, (near-)simultaneous source data dₜₒₜ(m) we have the following system of equations:

GD=Dₜₒₜ

And we can compute, e.g., the least-squares solution D^{LS}

D^{LS}=(G^{H}G+λ²I)⁻¹G^{H}Dₜₒₜ,

Where the stabilisation λ² is usually chosen to be a percentage (e.g. 0.1%) of the maximum of G^{H}G and ^{H} denotes complex-conjugate (Hermitian) transpose.

As in the example above, this variant can be applied successfully to the separation of a dataset to which two sources have been contributing to with one of the sources being modulated in such a manner.

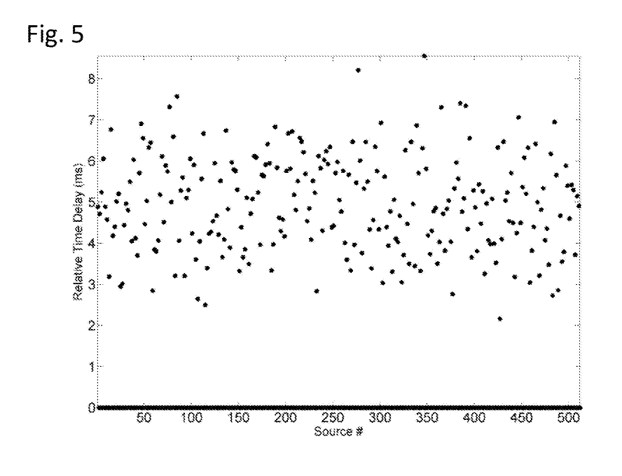

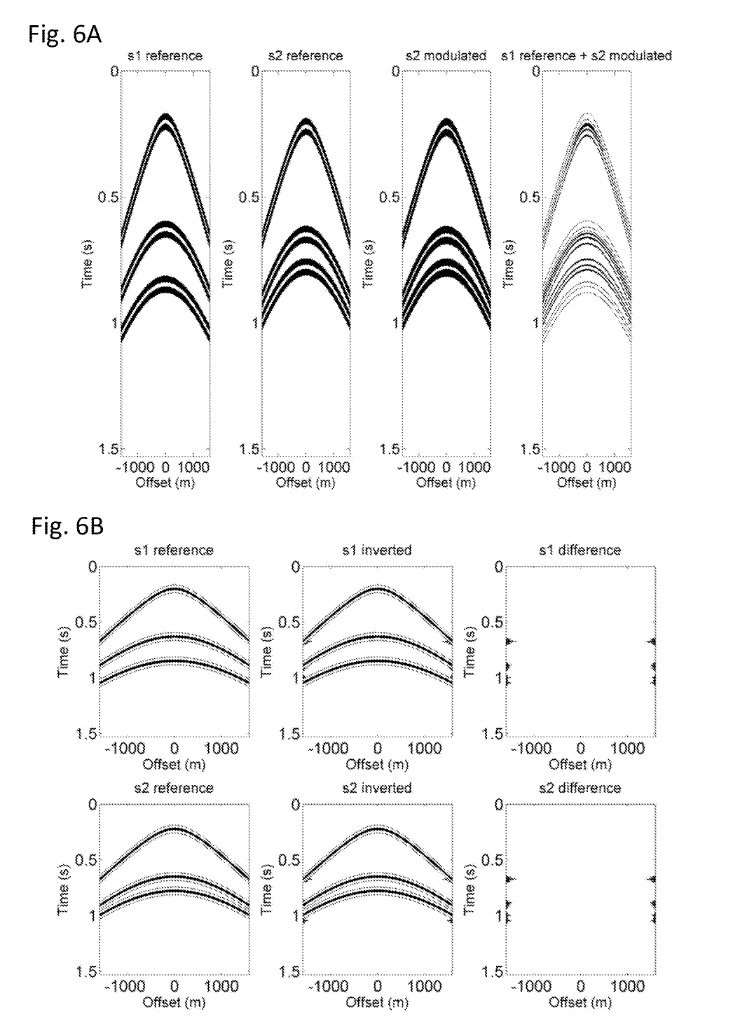

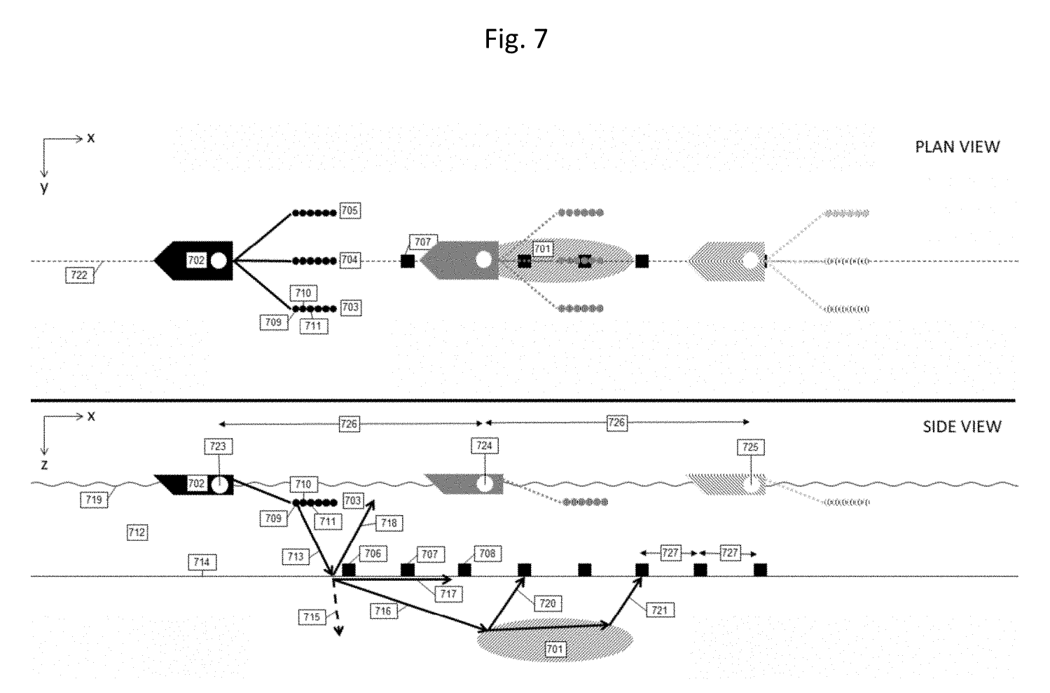

In FIG. 5 and FIG. 6, the methodology described above is illustrated. In FIG. 5, the relative time delays between source 1 and source 2 are shown. Note that every other trace, the relative time delay is zero. In FIG. 6A, the reference data for source 1 and source 2 are shown (first and second panel from the left). In the third and fourth panel from the left, the modulated s₂ data and the simultaneous source data, i.e., s₁ reference+s₂ modulated are shown. The latter represents the input data dₜₒₜ for the method described above. The resulting least-squares reconstruction of the data for s₁ and s₂ are shown in FIG. 6B. As can be seen, the two sources have been separated correctly.

Note that the exactly the same methods can be used to separate or approximately separate sources for which the relative time delay varies non-periodically for every trace (i.e., every shot). Such variations, if intentionally, can be termed pseudo-random variations.

Note that the description above has focussed on the separation of at least two simultaneous or near-simultaneous sources. But the methods described herein can also be applied to wave fields where one source is physical and a second source is virtual as induced by the presence of a free surface which is the subjected of a separate patent application. In such a case the current disclosure allows for the separation of recorded wave fields into ghost and ghost-free wave fields. Further details to such an application can be found in the patent application by the same applicant entitled “Method for deghosting and redatuming operator estimation” and filed in the United Kingdom at the same priority date as this application.

Throughout the description of the present disclosure we have made use of Fourier transforms to transform the data separating and isolating wave fields. It will be appreciated by those skilled in the art that other transforms such as Radon transforms, tau-p transforms, etc., can also be used for the same purpose. Furthermore, those skilled in the art may also prefer to implement the methods presented directly in the space and/or time domain. In such cases the transforms presented herein are replaced by their respective representations or mathematical equivalents in such domains, which can take either explicit or approximated/truncated forms and applied to the wave field data representation in the respective domain.

A bounded support in a domain is the well-known mathematical generalisation of the better-known concept of being bandlimited (such as in equation (1.1)). Examples of limited support are presented above.

It is well known, for example, that due to the “uncertainty principle”, a function and its Fourier transform cannot both have bounded support. As (seismic) data are necessarily acquired over a finite spatial (and temporal) extent, the terms “bounded support” and “limited support” herein are used not in the strict mathematical sense, but rather to describe an “effective numerical support”, that can be characterised, e.g., by the (amplitude) spectrum being larger than a certain value. For instance, larger than a certain noise threshold, or larger than the quantization error of the analog-to-digital converters used in the measurement equipment. Further, it is understood that by explicitly windowing space and/or space-time domain data, the support of a function may be spread over a larger region of, e.g., the wavenumber-frequency domain and in such cases the term “bounded support” and “limited support” will also be understood as “effective numerical support” as it will still be possible to apply the methods described herein.

Furthermore, the terms “cone” and “cone-shaped” used herein are used to indicate the shape of the “bounded” or “effective numerical” support of the data of interest (e.g., the data that would be recorded firing the sources individually [i.e. non-simultaneously]) in the frequency-wavenumber domain. In many cases, it will still be possible to apply the methods described herein if the actual support is approximately conic or approximately cone-shaped. For example, at certain frequencies or across certain frequency ranges the support could be locally wider or less wide than strictly defined by a cone. Such variations are contemplated and within the scope of the appended claims. That is, the terms “cone” and “cone-shaped” should be understood to include approximately conic and approximately cone-shaped. In addition, in some cases we use the terms “bounded support” or “limited support” and “effective numerical support” to refer to data with “conic support” or “cone-shaped support” even though in the strict mathematical sense a “cone” is not bounded (as it extends to infinite temporal frequency). In such cases, the “boundedness” should be understood to refer to the support of the data along the wavenumber axis/axes, whereas “conic” refers to the overall shape of the support in the frequency-wavenumber domain.

Note that the term “cone-shaped support” or similar refers to the shape of the support of e.g. the data of interest (in the frequency-wavenumber domain), if it were regularly sampled along a linear trajectory in 2D or Cartesian grid in 3D. That is, it refers only to the existence of such a support and not to the actual observed support of the data of interest in the simultaneous source input data or of the separated data of interest sampled as desired. The support of both of these depends on the chosen regularly or irregularly sampled straight or curved input (activation) and output (separation) lines or grids. Such variations are within the scope of the appended claims.

For example consider a case where the input data are acquired using simultaneous curved shot lines. In this case, the methods described herein can either be applied directly to the input data, provided the curvature has not widened the support of the data interest such that it significantly overlaps with itself. In this case, the support used in the methods described herein can be different from cone-shaped. Alternatively, the methods described herein are used to reconstruct the data of interest in a transform domain which corresponds to, e.g., best-fitting regularly sampled and/or straight activation lines or Cartesian grids, followed by computing the separated data of interest in the non-transformed domain at desired regular or irregularly sampled locations.

As should be clear to one possessing ordinary skill in the art, the methods described herein apply to different types of wave field signals recorded (simultaneously or non-simultaneously) using different types of sensors, including but not limited to; pressure and/or one or more components of the particle motion vector (where the motion can be: displacement, velocity, or acceleration) associated with compressional waves propagating in acoustic media and/or shear waves in elastic media. When multiple types of wave field signals are recorded simultaneously and are or can be assumed (or processed) to be substantially co-located, we speak of so-called “multi-component” measurements and we may refer to the measurements corresponding to each of the different types as a “component”. Examples of multi-component measurements are the pressure and vertical component of particle velocity recorded by an ocean bottom cable or node-based seabed seismic sensor, the crossline and vertical component of particle acceleration recorded in a multi-sensor towed-marine seismic streamer, or the three component acceleration recorded by a microelectromechanical system (MEMS) sensor deployed e.g. in a land seismic survey.

The methods described herein can be applied to each of the measured components independently, or to two or more of the measured components jointly. Joint processing may involve processing vectorial or tensorial quantities representing or derived from the multi-component data and may be advantageous as additional features of the signals can be used in the separation. For example, it is well known in the art that particular combinations of types of measurements enable, by exploiting the physics of wave propagation, processing steps whereby e.g. the multi-component signal is separated into contributions propagating in different directions (e.g., wave field separation), certain spurious reflected waves are eliminated (e.g., deghosting), or waves with a particular (non-linear) polarization are suppressed (e.g., polarization filtering). Thus, the methods described herein may be applied in conjunction with, simultaneously with, or after such processing of two or more of the multiple components.

Furthermore, in case the obtained wave field signals consist of/comprise one or more components, then it is possible to derive local directional information from one or more of the components and to use this directional information in the reduction of aliasing effects in the separation.

While various embodiments of the present disclosure have been described above, it should be understood that they have been presented by way of example only, and not of limitation. For example it should be noted that where filtering steps are carried out in the frequency-wavenumber space, filters with the equivalent effect can also be implemented in many other domains such as tau-p or space-time.

Further, it should be understood that the various features, aspects and functionality described in one or more of the individual embodiments are not limited in their applicability to the particular embodiment with which they are described, but instead can be applied, alone or in various combinations, to one or more of the other embodiments of the disclosure.

For example, it is understood that the techniques, methods and systems that are disclosed herein may be applied to all marine, seabed, borehole, land and transition zone seismic surveys, that includes planning, acquisition and processing. This includes for instance time-lapse seismic, permanent reservoir monitoring, VSP and reverse VSP, and instrumented borehole surveys (e.g. distributed acoustic sensing). Moreover, the techniques, methods and systems disclosed herein may also apply to non-seismic surveys that are based on wave field data to obtain an image of the subsurface.

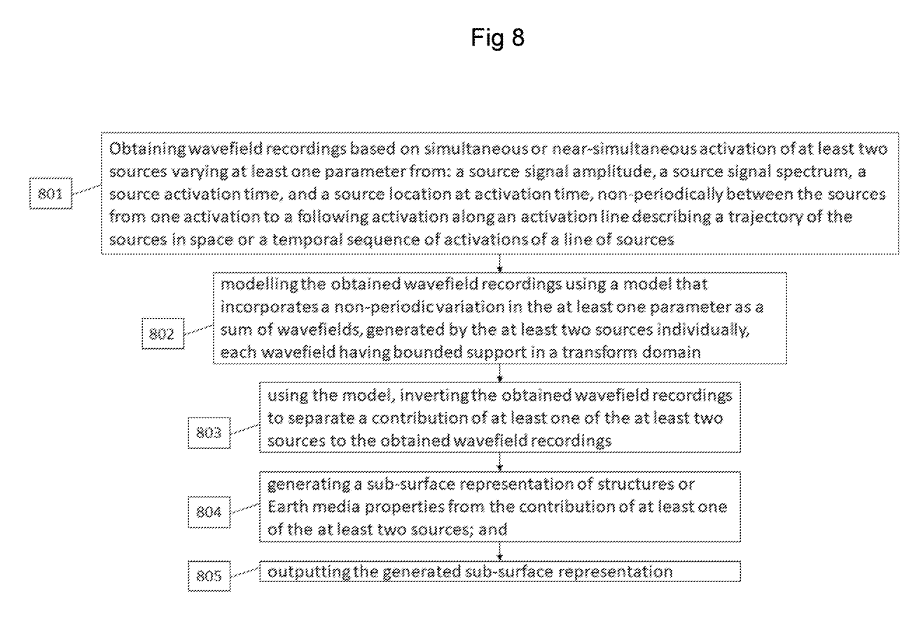

In FIG. 8, the relation between key steps in the methods proposed herein is summarized. In a first step, 801, wave field recordings are obtained based on the simultaneous or near-simultaneous activation of at least two sources varying at least one parameter from: a source signal amplitude, a source signal spectrum, a source activation time, and a source location at activation time, non-periodically between the sources from one activation to a following activation along an activation line describing a trajectory of the sources in space or a temporal sequence of activations of a line of sources. Then, in a second step, 802, the obtained wave field recordings are modelled, using a model that incorporates the non-periodic variation in the at least one parameter, as a sum of wave fields, generated by the at least two sources individually, the obtained wave filed recordings having bounded support in a transform domain. In a third step, 803, using the model, the obtained wave field recordings are inverted to separate a contribution of at least one of the at least two sources to the obtained wave field recordings. In a fourth step, 804, sub-surface representations of structures or Earth media properties are generated from the contribution of at least one of the at least two sources. Finally, in a fifth step, 805, the generated sub-surface representations are outputted.

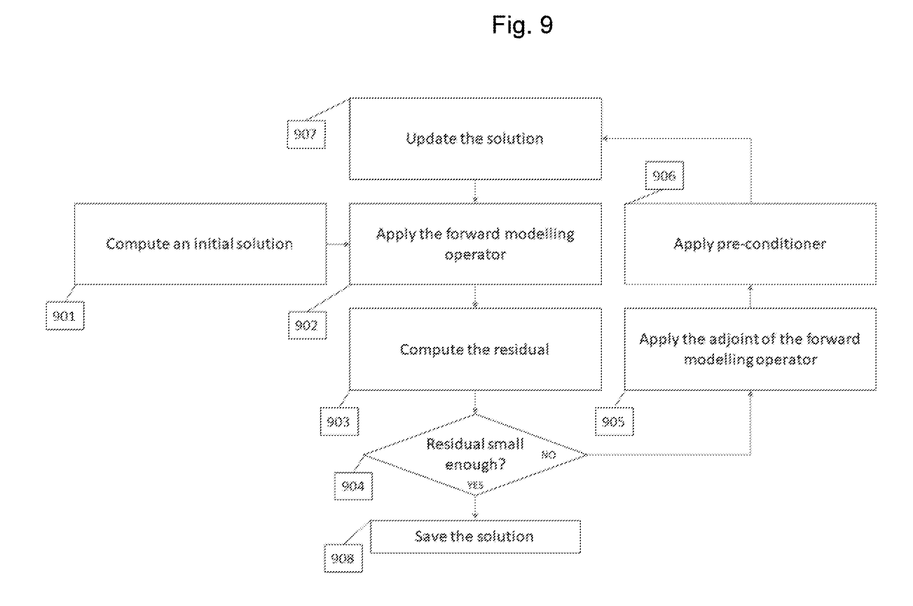

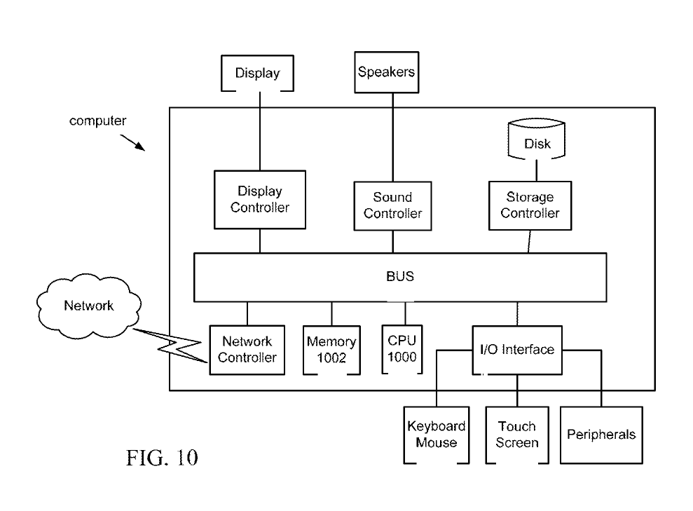

In FIG. 9, additional details are provided for the methods described herein in those cases that the inverting step (e.g., step 803 in FIG. 8) further comprises solving a system of equations iteratively. As explained previously, the system of equations relates all or part of the wave fields generated by at least two sources individually (in a transformed or untransformed domain) to all or part of the obtained wave fields (in a transformed or untransformed domain) using a model that incorporates the non-periodic variation (e.g., step 802 in FIG. 8). In a first step of the iterative solution, 901, an initial solution is computed, for example, assuming (in the model) periodic timing, periodic signal amplitude, periodic signal spectrum variations, and regular activation locations. Then, in a second step of the iterative solution, 902, the forward modelling operator that incorporates the non-periodic variation is applied to the initial solution to generate the obtained wave field recordings that would have been obtained if the initial solution were the correct solution. Then, in a third step, the residual is computing by differencing the modelled-obtained wave field recordings, and the (actual, measured) obtained wave field recordings and computing a suitable measure or norm of the difference. In a fourth step of the iterative solution, 904, the measure or norm of the difference is compared against a user-defined value to decide whether the residual is small enough. If this is the case, then in a last step of the iterative solution, 908, the solution is accepted as the final solution and saved to be used in further steps following the iterative solution of a system of equations. Alternatively, if this not the case, then, further steps of the iterative solution, 905-907, are applied. Specifically, in step 905, the adjoint of the forward modelling operator, is applied to the residual. And, in step 906, optionally, a pre-conditioner is applied the result of which is used, in step 907, to update the solution. Steps 902-907 are then repeated until either the residual is found to be small enough in step 904 or until the solution is found not to change anymore or a pre-defined number of iterations is reached.

The methods described herein may be understood as a series of logical steps and (or grouped with) corresponding numerical calculations acting on suitable digital representations of the obtained wave field quantities, and hence can be implemented as computer programs or software comprising sequences of machine-readable instructions and compiled code, which, when executed on the computer produce the intended output in a suitable digital representation. More specifically, a computer program can comprise machine-readable instructions to perform the following tasks:
(1) Reading all or part of a suitable digital representation of the obtained wave field quantities into memory from a (local) storage medium (e.g., disk/tape), or from a (remote) network location;
(2) Repeatedly operating on the all or part of the digital representation of the obtained wave field quantities read into memory using a central processing unit (CPU), a (general purpose) graphical processing unit (GPU), or other suitable processor. As already mentioned, such operations may be of a logical nature or of an arithmetic (i.e., computational) nature. Typically the results of many intermediate operations are temporarily held in memory or, in case of memory intensive computations, stored on disk and used for subsequent operations; and
(3) Outputting all or part of a suitable digital representation of the results produced when there no further instructions to execute by transferring the results from memory to a (local) storage medium (e.g., disk/tape) or a (remote) network location.

Computer programs may run with or without user interaction, which takes place using input and output devices such as keyboards or a mouse and display. Users can influence the program execution based on intermediate results shown on the display or by entering suitable values for parameters that are required for the program execution. For example, in one embodiment, the user could be prompted to enter information about e.g., the average inline shot point interval or source spacing. Alternatively, such information could be extracted or computed from metadata that are routinely stored with the seismic data, including for example data stored in the so-called headers of each seismic trace.

Next, a hardware description of a computer or computers used to perform the functionality of the above-described exemplary embodiments is described with reference to FIG. 10. In FIG. 10, the computer includes a CPU 1000 (an example of “processing circuitry”) that performs the processes described above. The process data and instructions may be stored in memory 1002. These processes and instructions may also be stored on a storage medium disk such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which computer communicates, such as a server or another computer.

Further, the claimed advancements may be provided as a utility application, background daemon, or component of an operating system, or combination thereof, executing in conjunction with CPU 1000 and an operating system such as Microsoft Windows 7, UNIX, Solaris, LINUX, Apple MAC-OS and other systems known to those skilled in the art.

The hardware elements in order to achieve the computer can be realized by various circuitry elements, known to those skilled in the art. For example, CPU 1000 can be a Xenon or Core processor from Intel of America or an Opteron processor from AMD of America, or may be other processor types that would be recognized by one of ordinary skill in the art. Alternatively, the CPU 1000 can be implemented on an FPGA, ASIC, PLD or using discrete logic circuits, as one of ordinary skill in the art would recognize. Further, CPU 1000 may be implemented as multiple processors cooperatively working in parallel to perform the instructions of the inventive processes described above.

### LIST OF CITED REFERENCES

C. E. Shannon, Proc. Inst. of Radio Eng. 37, 10 (1949).
H. Nyquist, Trans. AIEE. 47, 617 (1928).
L. T. Ikelle, Coding and Decoding: Seismic Data: The Concept of Multishooting. (Elsevier, 2010), Vol. 39.
R. Abma, D. Howe, M. Foster, I. Ahmed, M. Tanis, Q. Zhang, A. Arogunmati and G. Alexander, Geophysics. 80, WD37 (2015).
R. Kumar, H. Wason and F. J. Herrmann, Geophysics. 80, WD73 (2015).
M. B. Mueller, D. F. Halliday, D. J. van Manen and J. O. A. Robertsson, Geophysics. 80, V133 (2015).
J. O. A. Robertsson, R. M. Laws and J. E. Kragh, in Resources in the near-surface Earth, edited by G. Schubert, Treatise on Geophysics Vol. 11 (Elsevier-Pergamon, Oxford, 2015).
R. Bracewell, The Fourier Transform & Its Applications (McGraw-Hill Science, 1999).

1. A method, comprising:
obtaining wave field recordings generated by least one receiver based on simultaneous or near-simultaneous activation of at least two sources having at least one parameter, the at least one parameter being one of a source signal amplitude, a source signal spectrum, a source activation time, and a source location at activation time, the at least one parameter varying non-periodically between the at least two sources from one activation to a following activation along an activation line describing a trajectory of the at least two sources in space or a temporal sequence of activations of a line of the at least two sources;
modelling the obtained wave field recordings using a model that incorporates a non-periodic variation in the at least one parameter as a sum of wave fields, generated by the at least two sources individually, the obtained wave filed recordings having bounded support in a transform domain;
using the model, inverting the obtained wave field recordings to separate a contribution of at least one of the at least two sources to the obtained wave field recordings;
generating a sub-surface representation of structures or Earth media properties from the contribution of the at least one of the at least two sources; and
outputting the generated sub-surface representation.

2. The method of claim 1, wherein the bounded support comprises cone-shaped regions in a frequency wavenumber domain.

3. The method of claim 2, wherein the modelling step comprises modelling the obtained wave field recordings using unequally spaced discrete Fourier transform operators.

4. The method of claim 1, wherein the inverting step further comprises solving a system of equations.

5. The method of claim 4, wherein the inverting step further comprises solving the system of equations iteratively.

6. The method of claim 5, wherein the inverting step further comprises solving the system of equations iteratively including use of a preconditioner.

7. The method of claim 6, where the preconditioner includes at least one of a least-squares solution for periodic timing, signal amplitude, or signal spectrum variations, and regular activation locations.

8. The method of claim 1, wherein the variations include at least one of the source activation time, the source signal amplitude, and the source signal spectrum, and the model includes application of a cyclic convolution matrix and a corresponding inverse of the cyclic convolution matrix using a transform of a modulation function associated with the variations.

9. The method of claim 8, wherein the inverting step further comprises computing a least-squares solution of a system of equations.

10. The method of claim 1, wherein at least one source of the at least two sources is not part of the same survey, and wherein the activation time of the at least one source is approximately known.

11. The method of claim 10, wherein activation times are determined from the obtained wave field recordings.

12. The method of claim 1, wherein the at least one parameter is varied in a non-periodic controlled or uncontrolled manner.

13. The method of claim 1, wherein the at least one parameter is varied in a non-periodic manner and is composed of a periodic part overlaid with non-periodic fluctuations.

14. The method of claim 1, wherein the inverting step further comprises regularizing data onto a regular sampling grid in time and or space.

15. The method of claim 1, wherein the transform domain is one of a Fourier transform domain, a Radon transform domain, a Gabor time-frequency domain, and a tau-p transform domain.

16. The method of claim 15, wherein each corresponding transform is replaced by its respective representation or mathematical equivalent in corresponding transform domains in a space or time domain.

17. The method of claim 1, wherein computations in the modelling and inverting steps are performing using fast solvers to reduce the time complexity of the modelling and inverting steps.

18. The method of claim 1, wherein the obtained wave field recordings comprise multiple components, and one or more of the multiple components is modeled and inverted to separate the contribution using information derived from one or more of the other multiple components.

19. The method of claim 18, where the information derived from the one or more of the other multiple components comprises local directionality information.

20. The method of claim 18, further comprising determining local directionality information jointly from two or more of the multiple components.

21. An apparatus, comprising:
processing circuitry configured to
obtain wave field recordings generated by least one receiver based on simultaneous or near-simultaneous activation of at least two sources having at least one parameter, the at least one parameter being one of a source signal amplitude, a source signal spectrum, a source activation time, and a source location at activation time, the at least one parameter varying non-periodically between the at least two sources from one activation to a following activation along an activation line describing a trajectory of the at least two sources in space or a temporal sequence of activations of a line of the at least two sources;
model the obtained wave field recordings using a model that incorporates a non-periodic variation in the at least one parameter as a sum of wave fields, generated by the at least two sources individually, each of the wave fields having bounded support in a transform domain;
using the model, invert the obtained wave field recordings to separate a contribution of at least one of the at least two sources to the obtained wave field recordings;
generate a sub-surface representation of structures or Earth media properties from the contribution of the at least one of the at least two sources; and
output the generated sub-surface representation.
